(19) United States
(12) Patent Application Publication
(10) Pub. No.: US 2012/0135292 A1
(43) Pub. Date: May 31, 2012

(54) CONFORMAL SOLID STATE PACKAGE METHOD AND DEVICE FOR A BATTERY DEVICE

(75) Inventors: Stephen Buckingham, Ypsilanti, MI (US); Svetlana Lukich, Ann Arbor, MI (US); Ann Marie Sastry, Ann Arbor, MI (US); Marc Langlois, Ann Arbor, MI (US)

(73) Assignee: Sakti3, Inc., Ann Arbor, MI (US)

(21) Appl. No.: 13/356,570

(22) Filed: Jan. 23, 2012

Related U.S. Application Data
(63) Continuation-in-part of application No. 13/285,368, filed on Oct. 31, 2011.

(51) Int. Cl. H01M 10/02; H01M 4/26; B05D 3/12; B05D 1/02; C23C 4/12; B05D 1/18; H01M 10/04; B05D 5/00

(52) U.S. Cl. 429/153; 427/58; 427/458; 427/447; 427/596; 427/488; 427/122; 427/126.4; 427/126.3; 427/126.1

(57) ABSTRACT

A monolithically integrated thin-film solid-state lithium battery device to supply energy to a mobile communication device. The device includes a plurality of layers ranging from greater than 100 layers to less than 20,000 layers of lithium electrochemical cells, which may be connected in parallel or in series to conform to a spatial volume. The device also includes a polymer based coating characterized by a thickness to house the plurality of layers and configured as an exterior region for the battery device, the polymer based coating having a resistivity of 10¹² Ω.cm and higher. The device further includes a hermetic seal provided by the polymer-based coating to enclose and house the plurality of layers.

### CROSS-REFERENCES TO RELATED APPLICATIONS

The present application incorporates by reference, for all purposes, the following pending patent application: U.S. patent application Ser. No. 13/283,528, filed Oct. 27, 2011 (Attorney Docket No. 913RO-001300US), commonly assigned.

### BACKGROUND OF THE INVENTION

This present invention relates to manufacture of electrochemical cells. More particularly, the present invention provides a method and device for packaging a solid-state thin film battery device. Merely by way of example, the invention has been provided with use of lithium based cells, but it would be recognized that other materials such as zinc, silver, copper and nickel could be designed in the same or like fashion. Additionally, such batteries can be used for a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles). The design of such batteries is also applicable to cases in which the battery is not the only power supply in the system, and additional power is provided by a fuel cell, other battery, IC engine or other combustion device, capacitor, solar cell, etc.

Conventional metal Lithium of thin film solid-state batteries reacts rapidly to atmospheric elements such as oxygen, nitrogen, carbon dioxide and water vapor. Thus, the lithium anode of a thin film battery will react in an undesirable manner on exposure to such elements if the anode is not suitably packaged. An example of a package is discussed by Zhang in U.S. Pat. No. 7,204,862 B1, which is directed to a heat sealable package containing a thin Al or other metal foil as the barrier layer, a nylon outer layer for structural strength and a heat sealable polymer such as polyethylene (PE) or polypropylene (PP) as the heat seal layer. Another example is shown by Bates in U.S. Pat. No. 6,387,563 B1. Bates is directed to a method that uses a UV curable epoxy to seal a cover glass over the thin film battery deposited on a rigid ceramic substrate. Bates also discusses an alternate method in U.S. Pat. No. 5,561,004 B1 that uses a multilayer coating using alternating layers of polymer and ceramic or polymer and ceramic and metal barrier layers. Limitations, however, exist with these conventional techniques. Such techniques often rely upon cumbersome packages, which are expensive, and may also use complex equipment and processes.

To further complicate matters, conventional Li-ion battery technology uses a liquid or polymer electrolyte to carry the lithium ions between the anode and cathode during charge and discharge cycling. These electrolytes are complex formulations of solvents and salts that contain many additives to obviscate issues with reaction at the interface of the liquid with the cathode or anode interface. The packaging method for the existing technology must therefore contain the electrolyte during the packaging process to prevent it from running out of the cell or contaminating the packaging process. In addition, as disclosed by Fukuda et al in U.S. Pat. No. 6,245,456 B1, the packaging material must often be benign to the solvents and other additives that form the electrolyte solution. Taken together these factors are limiting in the methods that can be used to package existing Li-ion battery technologies.

Accordingly, it is seen that there exists a need for a method and materials to produce an improved package of a large scale, high capacity solid-state battery.

### BRIEF SUMMARY OF THE INVENTION

According to the present invention, techniques related to manufacture of electrochemical cells are provided. More particularly, the present invention provides a method and device for packaging a solid-state thin film battery device. Merely by way of example, the invention has been provided with use of lithium based cells, but it would be recognized that other materials such as zinc, silver, copper and nickel could be designed in the same or like fashion. Additionally, such batteries can be used for a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles). The design of such batteries is also applicable to cases in which the battery is not the only power supply in the system, and additional power is provided by a fuel cell, other battery, IC engine or other combustion device, capacitor, solar cell, etc.

In a specific embodiment, the present invention provides a monolithically integrated thin-film solid-state lithium battery device to supply energy to a mobile communication device. The device includes a plurality of layers ranging from greater than 100 layers to less than 20,000 layers of lithium electrochemical cells, which may be connected in parallel or in series to conform to a spatial volume. The device also includes a polymer based coating characterized by a thickness to house the plurality of layers and configured as an exterior region for the battery device, the polymer based coating having a resistivity of 10¹² Ω.cm and higher. The device further includes a hermetic seal provided by the polymer-based coating to enclose and house the plurality of layers.

In an alternative specific embodiment, the present invention provides a method for fabricating a monolithically integrated thin-film solid-state lithium battery device to supply energy to a mobile communication device. The method includes forming a plurality of layers ranging from greater than 100 layers to less than 20,000 layers of lithium electrochemical cells, which may be connected in parallel or in series to conform to a spatial volume. The method includes forming a polymer based coating characterized by a thickness to house the plurality of layers and configured as an exterior region for the battery device. Preferably, the polymer based coating has a resistivity of 10¹² Ω.cm and higher. The polymer based coating provides a hermetic seal to enclose and house the plurality of layers. In one or more embodiments, forming of the polymer based coating comprises dipping, spraying, or electrostatic spraying, flame spraying, arc spraying, laser spraying, atmospheric plasma polymerization, vacuum plasma polymerization, sub atmosphere condensation, spin coating, and atmospheric condensation, ultrasonic ammonization, modified atmosphere coating (Argon, etc), modified nano-spraying (fumed silica, etc.), and combinations thereof.

As further information, we have investigated features of a conventional pouch package, which has limitations. The pouch uses a laminated metal foil heat sealable packaging containing thin Al or other metal foil as the barrier layer, a nylon outer layer for structural strength and a heat sealable polymer such as polyethylene (PE) or polypropylene (PP) as the heat seal layer. The primary method used is to form a pouch from the heat sealable packaging material formed with a recess for inserting the cathode/anode/separator materials. Then a “lid” of similar heat sealable material is set over the pouch and the liquid electrolyte is injected to soak the cell electrodes immediately prior to heat sealing the lid to the pouch to enclose the battery. The laminated heat seal material itself is relatively thick (50-100 microns) and difficult to form conformally around the active battery materials and so the packaging itself and voids between it and the cell layers form a parasitic mass and volume that detracts from the overall energy density of the cell it is enclosing.

The extensive advantages in cost saving and manufacturing rate in addition to minimizing the mass and volume ratios of packaging to active cell materials to optimize the battery energy density in the packaging methods described herein are therefore not obvious or applicable to current battery technology.

The conventional techniques relate to methods for sealing individual thin film solid-state cells by depositing or applying over layer protective films or heat sealing the individual cells in a laminated package. This approach leads to a package mass and volume that is a significant fraction or even exceeds the active material of the cell. If these individually packaged solid-state cells are then stacked to increase the capacity to levels required in current hand held communications technologies this problem persists limiting the application of solid-state battery technology to niche markets where ultra thin solid-state cells meet requirements not achievable in other technologies.

For the larger capacity liquid and polymer electrolyte technologies, conventional packages use a laminated heat sealable design that is bulky and difficult to conform to the active cell materials.

Benefits are achieved over conventional techniques. Depending upon the specific embodiment, one or more of these benefits may be achieved. In a preferred embodiment, the present invention provides a hermetic packaging device for a solid-state battery and a method for making same. In a specific embodiment, the present invention provides a method for applying polymer based coatings by dip coating spraying, powder coating or otherwise forming thin protective conformal sheath around the cell that has specific functions. Preferably, the protective sheath may be comprised of several functionally graded over layers that are applied to achieve hermetic protection of the device, static discharge protection and mechanical protection. The coatings may also contain materials for gettering or desiccants. Preferably, the present package and method protects the active components from atmospheric elements and at the same time minimizes the parasitic mass and volume to optimize the battery energy density. Preferably, the present invention includes a method and device for a conformal solid-state package, which can accurately encapsulate a battery device, while protecting the battery electrically, mechanically, and environmentally. Of course, there can be other variations, modifications, and alternatives.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

The following diagrams are merely examples, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

FIG. 1 is a simplified diagram of a battery device having a polymer package according to an embodiment of the present invention;

FIGS. 2A-2D are simplified illustrations of a method of fabricating the battery device having the polymer based package according to an embodiment of the present invention;

FIG. 3 is a simplified flow diagram illustrating a method for depositing the polymer package for a battery device according to an embodiment of the present invention; and

FIG. 4 is an simplified diagram of an existing coating process that include a Parylene deposition process to form a highly conformal, pliable, pinhole free layer for the battery.

### DETAILED DESCRIPTION OF THE INVENTION

According to the present invention, techniques related to manufacture of electrochemical cells are provided. More particularly, the present invention provides a method and device for packaging a solid-state thin film battery device. Merely by way of example, the invention has been provided with use of lithium based cells, but it would be recognized that other materials such as zinc, silver, copper and nickel could be designed in the same or like fashion. Additionally, such batteries can be used for a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles). The design of such batteries is also applicable to cases in which the battery is not the only power supply in the system, and additional power is provided by a fuel cell, other battery, IC engine or other combustion device, capacitor, solar cell, etc.

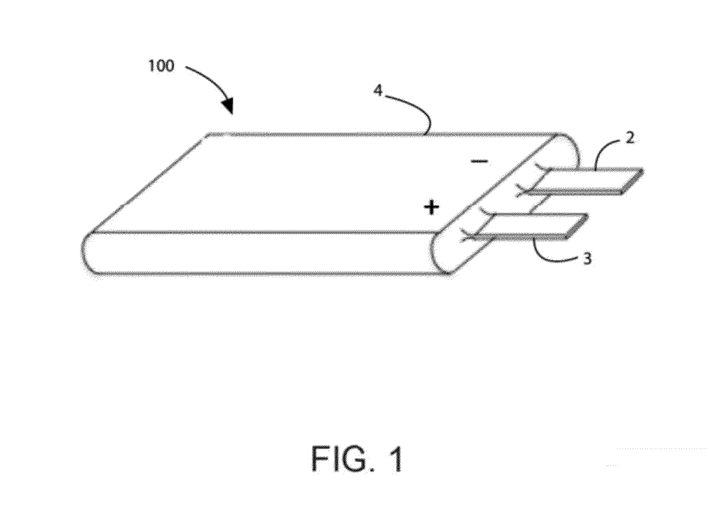

FIG. 1 is a simplified diagram of a battery device having a polymer package according to an embodiment of the present invention. As shown in step 100, battery device 4 is a thin film solid-state device. In an embodiment, battery device 4 is a monolithically integrated thin-film solid-state Lithium-ion battery accurately coated using the method of the present invention. Battery device 4 can be comprised of plurality of layers ranging from greater than 100 to less than 20,000 layers of Lithium electrochemical cell, which has been conformally coated by a polymer based coating. In a specific embodiment, battery device 4 has negative post or self terminated connector 2, which serves as a cathode, and positive post or self terminated connector 3, which serves as an anode. The positive and negative connector surfaces are not coated with the polymer based coating.

In a specific embodiment, the device has a substrate and the overlying multiple layers. The overlying multiple layers are free from any intermediary substrate member. The multiple layers are configured to form a plurality of electrochemical cells configured in a parallel arrangement or a serial arrangement using either a self terminated or post terminated connector configuration. In a preferred embodiment, the battery has an energy density of 500 Watt-hours/liter and greater.

Polymer based coating serves as an exterior region of battery device 4 from step 100, providing electrical, mechanical, and environmental protection. The coating provides protection to battery device 4 from water and water vapor, gas diffusion, under water diffusion, etc. Polymer based coating serves as static discharger, protector from oxygen, nitrogen, carbon dioxide, and other gases, provides mechanical protection, and durability.

In a specific embodiment, the polymer based coating has certain characteristics. The coating has a diffusion coefficient of 10⁻⁶ cm2/sec or less. The coating also has a water vapor transmission rate to <10⁻⁴ gm/m2/day. In one or more embodiments, the coating may be selected from epoxy, polyurethane, thermoplastics, acrylate ceramics, liquid crystals, phenol formaldehyde, butadiene or acrylonitrile, phthalic acid, polyvinylidene chloride, silicon, polytetrafluoroethylene, silica, graphite, carbon black, MgO, SiO₂, SiC, TiC, Al₂O₃, PMMA or combinations. Preferably, the polymer based coating has a sufficient rigidity and thickness to enclose the plurality of layers and provide mechanical protection to the plurality of layers. In a specific embodiment, the polymer based coating comprises a desiccant material (e.g., silicon rubber), a moisture barrier (e.g., polyethylene, polypropylene, humiseal), a static discharge material (e.g., PE, PET), or a plurality of gettering materials [e.g,. metal or alkaline earth metal (e.g., aluminum, calcium species), insulator, nanoparticle, semiconductor], among others, and combinations thereof, and the like. In a specific embodiment, the polymer based material comprises multi layers including barrier, getter, adhesion, modulus modifying, stress modifying, electrical conductivity modifying, color modifying, surface energy modifying. The polymer based material has a conformal characteristic and is pliable. Of course, there can be other variations, modifications, and alternatives.

In a specific embodiment, the present invention includes a battery device having selected spatial dimensions. The device has a spatial volume of 1 l and less. In other embodiments, the spatial volume may range from about 5 cc to about 100 cc. In other embodiments, the device can be configured in a mobile phone, computing device, or other application. Of course, there can be other variations, modifications, and alternatives.

A method of processing a battery device with a protective coating according to an embodiment of the present method can be briefly outlined below.

1. Start;

2. Provide substrate;

3. Form a plurality of layers ranging from greater than 100 layers to less than 20,000 layers of lithium electrochemical cells for a battery device;

4. Form connections to the battery device;

5. Optionally, process battery device;

6. Suspend battery device;

7. Dip the battery device in a polymer based in fluid state;

8. Cure the battery device;

9. Inspect the battery device;

10. Perform other steps, as desired; and

11. Stop.

Any of the above sequence of steps provides a method according to an embodiment of the present invention. In a specific embodiment, the present invention provides a method and system for packaging an electrochemical cell in three dimensions. Other alternatives can also be provided where steps are added, one or more steps are removed, or one or more steps are provided in a different sequence without departing from the scope of the claims herein. Further details of the present method can be found throughout the present specification and more particularly below.

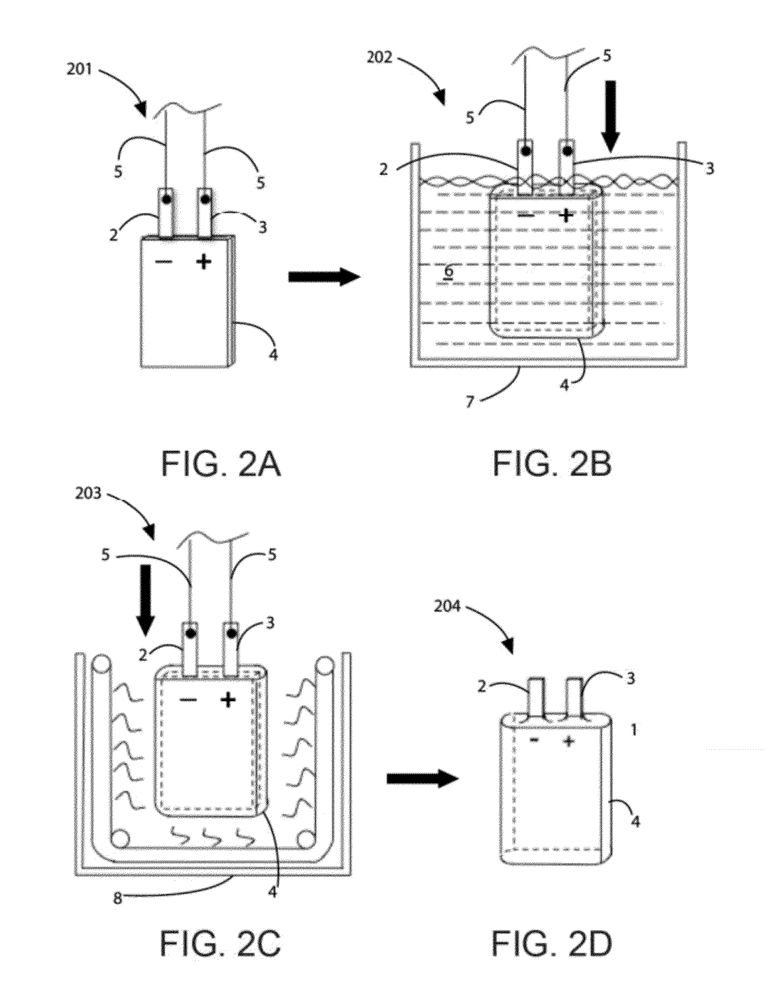

FIGS. 2A-2D are simplified illustrations of a method of fabricating the battery device having the polymer package according to an embodiment of the present invention.

As shown in step 201 of FIG. 2A, battery device 4 can be suspended by wires 5 in a carrier rack (not shown). In a specific embodiment, wires 5 are often made of a metal material and can be reused, if desired. Preferably, each of wires 5 are separated electrically from each other. In a preferred embodiment, battery device 4 is in a discharge state, although it may be slightly charged or charged in other embodiments.

In a specific embodiment, battery device 4 is first held in place with the bottom side facing downward as shown in FIG. 2A. In step 202, battery device 4 is transferred to a dipping process (FIG. 2B), which immerses battery device 4 in a container 7 with a polymeric fluid 6 in an uncured state or liquid state. In a specific embodiment, the coating process coats all of the external services of the battery device with a thickness of material except on a positive 3 post and a negative 2 post or self terminated connector surfaces. To prevent coating on the positive and negative connectors, the connector surfaces may be isolated with a temporary protective material. The protective material includes a paper tape, mask, or others. Of course, there can be other variations, modifications, and alternatives. In a preferred embodiment, conformal dipping takes place in the clean room under clean room conditions. The clean room conditions include a Class 100-1,000, 70° F. temperature parameters, and 2% to 10% RH (as low as 40 degree dew point). Of course, there can be variations, modifications, and alternatives.

In a next step, battery device 4 can be submerged into a coating vessel by way of the hanger and automated or semi-automated robot. The coating vessel is filled with coating material such humiseal and others. Preferably, the coating occurs at room temperature, although the temperature can be slightly higher or lower depending upon the embodiment. In a specific embodiment, the coating is humiseal and is formed at a thickness ranging from about 0.025 mm to about 0.25 mm. In a preferred embodiment, the method includes a dip speed controlled by hydraulic mechanics (not shown), which can control slow speed, for instance 2″ per minute.

In a specific embodiment, battery device 4 is coated with the polymer on all its surfaces except on termination connectors, which are not dipped into coating solution and are protected in case of over dipping. Alternatively, the entirety of the device is coated and the coating is subsequently removed from the connectors. When battery is pulled out of the coating vessel, the battery device is coated on all its surfaces. In a preferred embodiment, the coating process may be repeated many times, until a desired thickness of polymer coating is achieved. Of course, there can be other variations, modifications, and alternatives.

After battery device 4 is coated with the polymer coating, it is cured in a conventional, UV, or IR chamber 8 (step 203), shown in FIG. 2C. Alternatively, the coating may be self-curing, or the like. In other embodiments, curing may occur by heat, pressure, visible light, radiation, evaporation, and exposure to certain atmospheres, such as O₂. Of course, depending upon the particular coating material, there can be other techniques. In specific embodiment, the processes include a conformal dipping that occurs in the clean room under clean room conditions.

After battery device 4 has undergone the method of the present invention (FIG. 2D), the battery device may be processed in an ordinary way (step 204), which includes verification and acceptance testing prior to shipment of the device.

While the method described is the favored method, many alternatives may be used. For example, instead of the conformal dipping method, epoxy powder may be used to cover the surface prior to submerging of the device into the epoxy resin. In addition to this, arc-spray may be used for the coating application as an automated or semi-automated process.

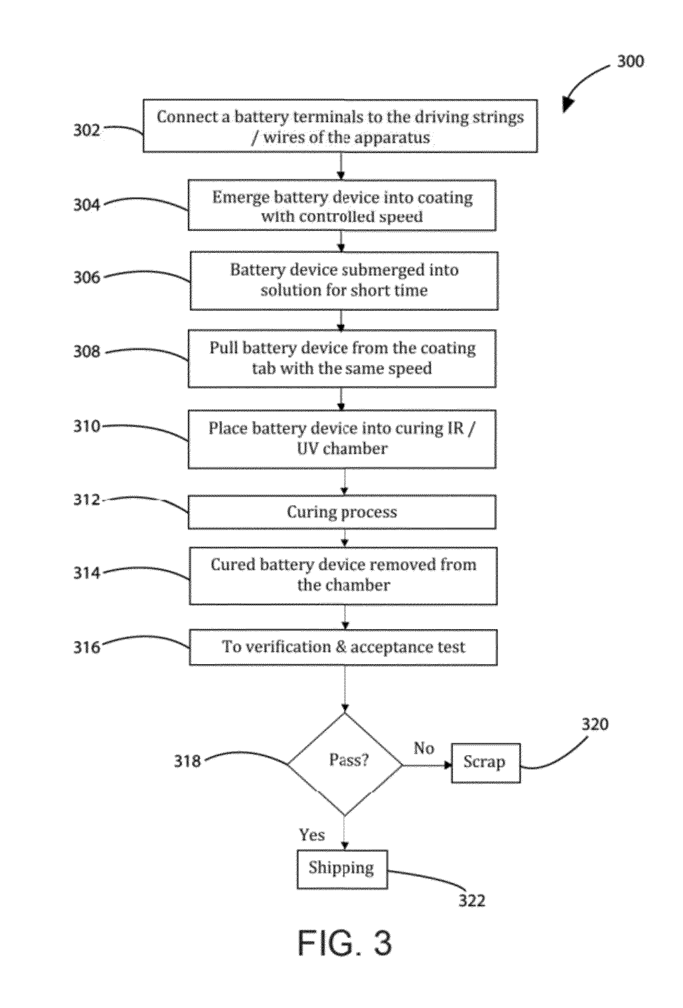

FIG. 3 is a simplified flow diagram illustrating a method for depositing the polymer package for a battery device according to an embodiment of the present invention. Method 300 can begin with the positive and negative connector surfaces being isolated by paper tape to prevent coating of the termination surface with the polymer based coating. Those skilled in the art will recognize other preparation methods used prior to a coating process. Also, the steps below will use reference numerals associated with FIGS. 1 and 2 to describe particular elements of battery devices and apparatuses used in methods according to embodiments of the present invention.

In step 304, the battery unit 4 is dipped in the polymer based coating 6 stored in the container 7 and coated therewith, as described. The battery is connected and held by wires 5, the elevation motor is driven to lower the height until the battery has been dipped into the liquid. The use of the motor can cause the coating to be applied at a controlled speed. Solvent temperature is approximately 25° C. and no vaporization of the solvent is present.

After battery is submerged completely into the solvent 6 for a short time, step 306, the motor is driven to raise the height and the battery is pulled out of the polymer based coating, step 308. As a result, the coating 6 is applied to the battery surface as a packaging layer. This process may be repeated as many times as needed until desired thickness of the packaging is reached. The liquid in the coating container is occasionally stirred and tuned with apparatus (not shown) to maintain desired viscosity.

After the battery device is coated with the polymer based coating, it is cured in a conventional, UV, or IR chamber 8. After battery device 4 was coated by polymer based coating, while still connected and held by wires 5, it is positioned at the curing station and the elevation motor is driven to lower the height until the battery has been positioned into a curing chamber 8, step 310. The battery device 4 is cured inside a conventional, UV, or IR radiation chamber, step 312.

With completion of the curing process, the battery device 4 is released to the next step, which includes verification and acceptance testing prior to shipment of the device, step 316. Depending on the quality according to passing condition 318, device 4 may be scrapped, step 320, or allowed for shipment, step 322.

In a preferred embodiment, metal tabs are attached to the solid-state battery cell formed with a plurality of battery cells over coated with a hermetic thin film barrier layer or layers. These barriers provide excellent protection for the battery from the post processing packaging methods detailed below. The contact region formed by self termination or post termination of the current collectors of the battery stack is exposed at the perimeter of the barrier layer by masking or etching or other process, and has terminal leads securely connected by a method from a list including laser welding, ultra sonic welding, cold welding, conductive epoxy or other method.

These methods provide for excellent bond strength that now allows the device to be handled by contact only with the attached leads leaving the battery structure exposed for application of a variety of packaging layers. The layered or functionally graded coverages that are used are defined by the specific application for the battery.

The variety of layering methods that can be utilized is significantly expanded by the effective barrier properties of the thin film barrier layer deposited on the solid-state battery device. This existing layer allows the use of packaging coatings that contain solvents or evolve solvents or other chemically reactive compounds that would normally prevent the use of such methods to coat a battery device of other chemistries such as for instance current Li ion battery technologies that utilize a liquid or polymer electrolyte. Exposing a cell with a liquid or polymer electrolyte in a process to form an ultra thin coating, as a packaging solution described herein would result in significant degradation if not complete failure of the cell. This dramatically expands the available packaging processes that can be applied to the solid-state battery including very mature and controlled processes that are already used in the electronics industry for example in the coating of printed circuit boards (PCB) and in capacitor packaging. Many materials are fast drying and can be applied by dip or spray coating in a rapid process using conventional equipment requiring only an exhaust hood to carry away vapor and mist from the process.

In an embodiment, the battery held by the leads is completely submerged or dip coated as in FIGS. 2A-2D with a material which when cured provides excellent barrier properties to the ingress of gaseous contamination from air exposure. For example Humiseal UV 40, which has been manufactured and sold by HumiSeal S.A.R.L, 4/6 Avenue Eiffel, 78420 Carrierses-Sur-Seine, France, is a UV curable barrier layer that even allows for the device to be submerged in water for a short period. Existing developed equipment can be purchased to apply and cure the coating, which forms a barrier to moisture and other gases as well as a mechanically sound structure against impact and wear. Humiseal UV 40 can be soldered through or chemically etched to make contacts post processing.

If a particular application of the battery requires the use of push-fit contacts a softer coating can be applied to ease the use of push fit and avoid the risk of damaging the connector. Acrylic coatings or some urethanes are more applicable in this application. Such materials include acrylic polymers epoxies urethanes applied by dip coating, spray coating, powder coating, gravure coating, combinations thereof, and the like. The curing process that forms the coating from its precursor materials is cured by heating, application of UV or IR radiation.

In another embodiment the battery may be additionally coated with an anti static material to prevent charge build up on the body of the device that may cause static discharge that could be detrimental to the battery itself. The conductive conformal coating can again be applied by using many conventional methods. Existing products in this field include Invisicon® which is applied in a 2-step process to form a highly transparent conductive coating exhibiting exceptional characteristics such as durability and index matching, This is accomplished using a wide variety of deposition and patterning methods performed in air with water based inks onto the battery as substrate. Carbon nanotube based inks dry to form a continuous electrically conductive network across a surface. The solvents in the ink evaporate and allow the self-assembly of nanotubes and bundles of nanotubes into larger filaments, unhindered by the presence of surfactants or other fillers. Essentially the nanotubes are attracted to one another, due to their small diameter, and build a porous network. At this stage of processing, layer is a composite of nanotubes and air. Carbon nanotube based inks dry to form a continuous electrically conductive network across a surface. The solvents in the ink evaporate and allow the self-assembly of nanotubes and bundles of nanotubes into larger filaments, unhindered by the presence of surfactants or other fillers. Essentially the nanotubes are attracted to one another, due to their small diameter, and build a porous network. At this stage of processing, one could think of this layer as composite of nanotubes and air. The layer of nanotube filaments can be infiltrated with a wide variety of materials to impart secondary properties to the conductive network. This infiltration step is not always needed, but depending on the application it is often beneficial, as it allows for engineering of this layer to adapt to other device layers or to impart other characteristics. The infiltrating materials most often selected are polymers and metal oxides, deposited using any wet coating technique. The advantage of this approach is again that it allows independent engineering of the chemical, electrical, mechanical, and optical properties of the layer, while utilizing industry standard processing and materials technologies.

The layers are all conformal and can be applied in a very thin layer so as to limit the parasitic mass and volume of this packaging so as to minimize any detriment to the energy density of the active cell structure.

While not necessarily desirable from a process or capital equipment point of view there are also vacuum deposition processes that can provide excellent coatings of extremely thin layers with excellent properties such as atomic layer deposition ALD which may also be applied. For this process the cell would be loaded into a large chamber in a vacuum batch process. Atomic layer deposition (ALD) is a thin film deposition technique that is based on the sequential use of a gas phase chemical process. The majority of ALD reactions use two chemicals, typically called precursors. These precursors react with a surface one-at-a-time in a sequential manner. By exposing the precursors to the growth surface repeatedly, a thin film is deposited.

ALD is a self-limiting (the amount of film material deposited in each reaction cycle is constant), sequential surface chemistry that deposits conformal thin-films of materials onto substrates of varying compositions. ALD is similar in chemistry to chemical vapor deposition (CVD), except that the ALD reaction breaks the CVD reaction into two half-reactions, keeping the precursor materials separate during the reaction. Due to the characteristics of self-limiting and surface reactions, ALD film growth makes atomic scale deposition control possible. By keeping the precursors separate throughout the coating process, atomic layer control of film growth can be obtained as fine as ˜0.1 Å(10 pm) per cycle. Separation of the precursors is accomplished by pulsing a purge gas (typically nitrogen or argon) after each precursor pulse to remove excess precursor from the process chamber and prevent ‘parasitic’ CVD deposition on the substrate. The benefits of ALD are that the ultra thin layer can be deposited without any defects in the structure that occurs using other deposition processes such as PVD. These defects allow moisture or other gases to pass through the layer. So although the deposition process requires multiple iterations to deposit a film, the film barrier properties far exceed thicker films formed by other methods.

Therefore in an embodiment of the current invention an aluminum oxide barrier would be deposited by atomic layer deposition followed by a spray or dip coated layer with the additional properties to provide protection for the ultra thin deposited film in terms of mechanical strength and wear protection.

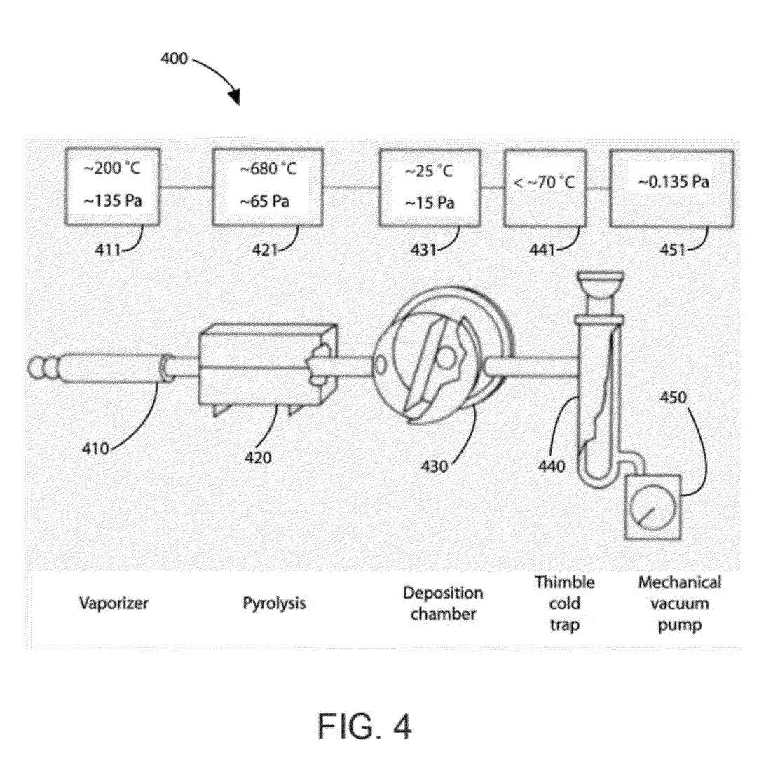

In another embodiment a layer of Parylene might be used to provide a film coating on the battery structure that allows for some pliability of the cell during its charge and discharge cycles. During cycling the battery may (in some chemical configurations) undergo expansion and contraction as the Li ions shuttle from the cathode layer to the anode layer and back. Small changes in structure or dimensions of these layers may result. Therefore, when a large number of cell elements are stacked on top of each other these dimensional changes are amplified resulting in larger changes that may need to be compensated by pliability of a layer of the package. The family of materials known as Parylenes would be ideal for this purpose. Parylenes are capable of being prepared as pinhole free coatings of outstanding conformality and uniformity of thickness by virtue of the unique chemistry of their precursors. In the Parylene process seen in FIG. 4 below the battery is exposed to a controlled atmosphere of pure gaseous monomer p-xylylene III (PX). The deposition process is a vapor deposition polymerization. The monomer itself is thermally stable but kinetically unstable. Although stable as a gas at low pressure it spontaneously polymerizes upon condensation to produce a coating of high molecular weight, linear poly (p-xylylene) (PPX(I). The process takes place in two stages that must be physically separate but temporarily adjacent. This method is again a batch process but very large chambers can be used to achieve high levels of productivity and a continuous process for deposition can be devised. In addition to providing a dimensionally accommodating coating the Parylenes are stable in contact with lithium metal and so can work well where exposed lithium is a possibility.

FIG. 4 is a simplified diagram of an existing coating process that could include a Parylene deposition process to form a highly conformal, pliable, pinhole free layer for the battery.

An embodiment of an apparatus 400 used as an example of known coating technology is in shown in FIG. 4. This apparatus includes a vaporizing chamber 410, a pyrolysis chamber 420, a deposition chamber 430, a thimble cold trap 440, and a mechanical vacuum pump 450. In a specific embodiment, the experimental results for temperature and pressure during processing can be found in the respective labels (411, 421, 431, 441, & 451), above apparatus 400, corresponding to each of the apparatus components (410, 420, 430, 440, & 450), respectively. Of course, those skilled in the art will recognize other variations, modifications, and alternatives.

Nanoparticle infused materials wherein the nanoparticle material acts a getter or desiccant for gases or vapors to which the package may be exposed. The plurality of coatings can also be chosen to provide the required packaging parameters and to be compatible with one another in terms of adhesion to one another and in terms of compatibility of their curing process wherein the curing process of an outer layer does not significantly affect the layers beneath.

Example: As described herein, the present example is merely an illustration, which should not unduly limit the scope of the claims herein. One of ordinary skill in the art would recognize other variations, modifications, and alternatives. In this example, certain conventional battery devices were coated to demonstrate the novelty and non-obvious of the present device and method. The conventional battery includes an anode, a cathode, current collectors, and an electrolyte. The conventional battery is not sealed and is subject to damage from harsh solvents in the dipping process. Such solvents include, but are not limited to, hexane, toluene, and methyl ethyl ketone. Such solvents migrate into the conventional battery device and cause damage to electrolyte & separator materials by dissociating the molecular bonds.

In contrast, the present solid-state battery device is a monolithically integrated thin-film solid-state lithium battery device including a plurality of layers ranging from greater than 100 layers to less than 20,000 layers of lithium electrochemical cells. The lithium electrochemical cells are connected in parallel or in series to conform to a spatial volume. The solid-state battery device includes a barrier material overlying the electrochemical cells to prevent undesirable species from diffusing into the cells. The barrier material covers an entirety of the electrochemical cells. The barrier material has a thickness ranging from about 30 nm to 300 nm. In this example the barrier material comprises lithium phosphate material. An example of a barrier material can be found in co-pending U.S. patent application Ser. No. 13/283,528, filed Oct. 27, 2011 (Attorney Docket No. 913RO-001300US), which is incorporated by reference in its entirety herein.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A monolithically integrated thin-film solid-state lithium battery device to supply energy to a mobile communication device, the battery device comprising:
a plurality of layers ranging from greater than 100 layers to less than 20,000 layers of lithium electrochemical cells, the lithium electrochemical cells being connected in parallel or in series to conform to a spatial volume;
a polymer based coating characterized by a thickness to house the plurality of layers and configured as an exterior region for the battery device, the polymer based coating having a resistivity of 10¹² Ω.cm and higher; and
a hermetic seal provided by the polymer based coating to enclose and house the plurality of layers.

2. The device of claim 1 further comprising a diffusion coefficient of 10⁻⁶ cm²/sec and less characterizing the polymer based coating.

3. The device of claim 1 further comprising water vapor transmission rate to <10⁻⁴ gm/m²/day.

4. The device of claim 1 wherein the polymer based coating is selected from epoxy, polyurethane, thermoplastics, acrylate ceramics, liquid crystals, phenol formaldehyde, butadiene or acrylonitrile, phthalic acid, polyvinylidene chloride, silicon, polytetrafluoroethylene, silica, graphite, carbon black, MgO, SiO₂, SiC, TiC, Al₂O₃, PMMA or combinations.

5. The device of claim 1 wherein the polymer based coating having a sufficient rigidity and thickness to enclose the plurality of layers and provide mechanical protection to the plurality of layers.

6. The device of claim 1 further comprising a substrate and the overlying multiple layers; wherein the overlying multiple layers are free from any intermediary substrate member; wherein the multiple layers are configured to form a plurality of electrochemical cells configured in a parallel arrangement or a serial arrangement using either a self terminated or post terminated connector configuration.

7. The device of claim 1 further comprising an energy density of 500 Watt-hours/liter and greater.

8. The device of claim 1 wherein the spatial volume is 1 liter and less;
wherein the polymer based coating comprises a desiccant material, wherein the polymer based material comprises a moisture barrier; wherein the polymer based material comprises a static discharge material; wherein the polymer material comprises a plurality of gettering materials.

9. The device of claim 1 wherein the polymer based material comprises multi layers including barrier, getter, adhesion, modulus modifying, stress modifying, electrical conductivity modifying, color modifying, surface energy modifying.

10. The device of claim 1 wherein the polymer based material has a conformal characteristic and is playable.

11. A method for fabricating a monolithically integrated thin-film solid-state lithium battery device to supply energy to a mobile communication device, the method comprising:
providing a plurality of layers ranging from greater than 100 layers to less than 20,000 layers of lithium electrochemical cells, the lithium electrochemical cells being connected in parallel or in series to conform to a spatial volume;
forming a polymer based coating characterized by a thickness to house the plurality of layers and configured as an exterior region for the battery device, the polymer based coating having a resistivity of 10¹² Ω.cm and higher; and
whereupon the polymer based coating characterized by a hermetic seal provided by the polymer based coating to enclose and house the plurality of layers.

12. The method of claim 11 further comprising a diffusion coefficient of 10⁻⁶ cm²/sec and less characterizing the polymer based coating.

13. The method of claim 11 further comprising a water vapor transmission rate to <10⁻⁴ gm/m²/day; wherein the polymer based material has a conformal characteristic and is pliable.

14. The method of claim 11 wherein the polymer based coating is selected from epoxy, polyurethane, thermoplastics, acrylate ceramics, liquid crystals, phenol formaldehyde, butadiene or acrylonitrile, phthalic acid, polyvinylidene chloride, silicon, polytetrafluoroethylene, silica, graphite, carbon black, MgO, SiO₂, SiC, TiC, Al₂O₃, PMMA or combinations.

15. The method of claim 11 wherein the polymer based coating having a sufficient rigidity and thickness to enclose the plurality of layers and provide mechanical protection to the plurality of layers.

16. The method of claim 11 further comprising a substrate and the overlying multiple layers; wherein the overlying multiple layers are free from any intermediary substrate member; wherein the multiple layers are configured to form a plurality of electrochemical cells configured in a parallel arrangement or a serial arrangement using either a self terminated or post terminated connector configuration.

17. The method of claim 11 further comprising an energy density of 500 Watt-hours/liter and greater.

18. The method of claim 11 wherein the spatial volume is 1 liters and less; wherein the polymer based coating comprises a desiccant material; wherein the polymer based coating comprises a moisture barrier; wherein the polymer based material comprises a static discharge material; wherein the polymer based material comprises a plurality of gettering materials.

19. The method of claim 11 wherein the polymer based material comprises multi layers including barrier, getter, adhesion, modulus modifying, stress modifying, electrical conductivity modifying, color modifying, surface energy modifying.

20. The method of claim 11 wherein the forming of the polymer based coating comprises dipping, spraying, or electrostatic spraying, flame spraying, arc spraying, laser spraying, atmospheric plasma polymerization, vacuum plasma polymerization, sub atmosphere condensation, spin coating, and atmospheric condensation, ultrasonic ammonization, modified atmosphere coating (Argon, etc), modified nano-spraying (fumed silica, etc.), and combinations thereof.
